(19) United States
(12) Patent Application Publication
(10) Pub. No.: US 2016/0061234 A1
(43) Pub. Date: Mar. 3, 2016

(54) HYDRAULIC FLUID RESERVOIR WITH IMPROVED DE-AERATION

(71) Applicant: PRICE ENGINEERING CO., INC., Hartland, WI (US)

(72) Inventors: Robert C. Doll, Nashotah, WI (US); Grant Griffiths, Sun Prairie, WI (US)

(21) Appl. No.: 14/781,995

(22) PCT Filed: Apr. 2, 2014
(86) PCT No.: PCT/US2014/032615

§ 371 Date: Oct. 2, 2015

Related U.S. Application Data
(60) Provisional application No. 61/807,939, filed on Apr. 3, 2013.

(51) Int. Cl. F15B 21/04; F15D 1/00

(52) U.S. Cl. CPC F15B 21/044; F15D 1/0005; F15D 1/0015

(57) ABSTRACT

A hydraulic fluid reservoir for de-aerating a hydraulic fluid received therein. The hydraulic fluid reservoir is of a type including two chambers separated by an intermediate baffle with a central opening connecting the chambers. In the lower chamber, cyclonic flow may be used to separate the aerated fluid from the de-aerated or non-aerated fluid and may be assisted by an inverted velocity cone. In the upper chamber, there may be a second state nucleation device, such as a mesh screen, that assists in removing entrained gases from the fluid by providing points of for the gas to nucleate thereon or collect. Additionally, a distribution header may be located in the upper chamber that returns fluid from the upper chamber to the lower chamber via a connection of the header to the return port at an eductor.

### CROSS-REFERENCE TO RELATED APPLICATION

This application claims the benefit of the filing date of U.S. Provisional Patent Application No. 61/807,939 filed Apr. 3, 2013, which is hereby incorporated by reference for all purposes as if set forth in its entirety herein.

### STATEMENT OF FEDERALLY SPONSORED RESEARCH OR DEVELOPMENT

Not applicable.

### BACKGROUND

This disclosure relates to a reservoir for hydraulic fluid. In particular, this disclosure relates to improvements to hydraulic fluid reservoirs that enhance de-aeration of the hydraulic fluid before the fluid is reintroduced into the rest of the hydraulic system.

In hydraulic systems in which hydraulic fluid is circulated by pumps, it is possible for the fluid to become aerated (i.e., for dispersed gas bubbles to develop in the hydraulic fluid). Such aeration can occur, for example, when excessive vacuum is created between the pump and the reservoir or when components create high velocities causing a vacuum. When aeration occurs, the bubbles can implode at an inlet end of the pump or downstream of throttle points, creating forces great enough to erode system components or result in oxidation of the hydraulic fluid, which is typically oil.

To de-aerate an aerated fluid, hydraulic systems are often provided with fluid reservoirs having a large volume such that the fluid may dwell for some length of time in the reservoir. As large reservoirs are expensive (and, in some environments or applications, impractical) smaller de-aerating reservoirs have been developed such as the reservoir found in U.S. Pat. No. 5,918,760. In this reservoir, a two-chamber cylindrical reservoir is disclosed in which a disc with an opening separates the two chambers. The lower chamber receives the hydraulic fluid tangentially from the system and provides the hydraulic fluid back to the system tangentially. While in the lower chamber this fluid spins causing centrifugal force. Less dense, aerated fluid migrates to the center of the lower chamber and through the opening into the upper chamber. More dense non-aerated fluid migrates to the wall. In the upper chamber, there is a wall member which inhibits further rotation of the fluid. The segregated aerated fluid remains in the upper chamber, where the fluid is given time to de-aerate via gravity. Gas bubbles slowly migrate to the upper surface of the oil for separation from the oil. Once separated, any released gas is allowed to escape from an opening in the upper chamber to the outside environment.

### SUMMARY OF THE INVENTION

However, even a reservoir such as that from U.S. Pat. No. 5,918,760 may not de-aerate the hydraulic fluid particularly efficiently. Among other things, the fluid must at times flow both up and down through the same central opening in the disc. Further, once the aerated fluid enters the upper chamber, there is no way to avoid the fact that time is required to pass for the entrapped gas to migrate upward through the hydraulic fluid and to separate from the fluid.

Hence, there remains a need for more efficient de-aeration reservoirs in which additional mechanisms advance the process of de-aeration. In this application, additional improvements are disclosed for cyclonic-type reservoirs that can significantly improve the de-aeration process. These improvements can be employed either separately or synergistically in combination with one another. These improvements include the presentation of an inverted velocity cone in the lower chamber to improve separation of less-dense aerated fluid from de-aerated or non-aerated fluid, the introduction of a mesh screen into the upper chamber to serve as a second stage nucleation or de-aeration device, and the addition of a distribution header into the upper chamber that returns fluid from the upper chamber back into the lower chamber via an eductor.

A hydraulic fluid reservoir is disclosed for de-aerating a hydraulic fluid received therein. The hydraulic fluid reservoir extends vertically along a central axis and has a lower chamber and an upper chamber which may be vertically disposed along this axis. The lower chamber and the upper chamber are separated by an intermediate baffle. A central opening is formed relative to the lower chamber in the intermediate baffle and places the upper chamber and the lower chamber in fluid communication with one another. The lower chamber has a return port and a suction port. The return port is for introducing the hydraulic fluid to the lower chamber in such a way that it creates a cyclonic flow in the lower chamber. The suction port is for removing the hydraulic fluid from the lower chamber and returning it to the rest of the hydraulic system.

In one form, the hydraulic fluid reservoir further includes an inverted velocity cone axially disposed in the lower chamber of the hydraulic fluid reservoir. The inverted velocity cone generates a velocity differential between the hydraulic fluid spinning at a top end of the lower tank in comparison to the hydraulic fluid spinning at a lower end of the lower chamber. The creation of this velocity differential improves separation of aerated and de-aerated portions of the hydraulic fluid from one another in the lower chamber.

The baffle may include a lower surface that extends upward in the axial direction as the lower surface of the baffle extends radially toward from the central opening. This lower surface of the baffle may provide a flow path from the lower chamber to the upper chamber between a top rim of the inverted velocity cone and the lower surface of the baffle. Further, in contrast to a flat-bottomed baffle, the angled baffle may provide a gravity-assisted path for gas bubbles in the hydraulic fluid to rise from the lower chamber into the upper chamber and to be directed through the central opening of the intermediate baffle.

The return port and the suction port may extend through generally cylindrical side walls of the lower chamber. To promote efficient cyclonic flow patterns, the return port may be oriented to introduce the hydraulic fluid into the lower chamber in a direction generally tangential to the cylindrical side walls and the suction port may be oriented to receive the hydraulic fluid from the lower chamber in a direction generally tangential to the cylindrical side walls. To help avoid the reception of an aerated portion of the fluid into the suction port, the return port may be disposed at a greater axial height than the suction port. Further to this end and with respect to the inverted velocity cone, a radial distance from the return port to the inverted velocity cone at the axial height of the return port can be less than a radial distance from the suction port to the inverted velocity cone at the axial height of the suction port.

The return port and the suction port may be designed to facilitate easy construction and to improve the efficiency of the cyclonic flow in the lower chamber. For example, the return port may include a tube with an end extending into an inner volume of the lower chamber such that, when fluid exits the return port from the end of the tube, the fluid enters the cyclonic flow in a tangential direction thereby enhancing spin efficiency. It is contemplated that the end of the tube may be straight cut and may protrude into the lower chamber, thereby allowing for a simple outside weld during fabrication. With respect to the suction port, the suction port may include a tube with an end having an angled cut that projects into the lower chamber.

The hydraulic fluid reservoir can also include a mesh screen in the upper chamber for initiating nucleation of an aerated portion of the hydraulic fluid and promoting aggregation of gas bubbles. It is contemplated that the mesh screen might be used in combination with the inverted velocity cone described herein or might be used separately from an inverted velocity cone.

In some forms, the mesh screen may be frusto-conical in shape and may extend axially upward as the mesh screen extends radially away from the central opening of the baffle. In one particular form, the mesh screen may be a 60 mesh screen and may be angled 30 degrees from a plane perpendicular from the central axis. However, other mesh sizes, angular orientations, or shapes of the screen might be employed.

The hydraulic fluid reservoir may also include a distribution header in the upper chamber in which the distribution header is in fluid communication with the return port via a return line connecting to the return port at an eductor. This permits direct reintroduction of fluid from the upper chamber into the lower chamber via the return port.

It is further noted that the eductor may provide a venturi at the joint of the eductor and the return port to draw fluid from the upper chamber through the return line and the eductor into the return port for reintroduction into the lower chamber.

It is contemplated that this distribution header could be separately employed in the two-chamber reservoir or may be used in combination with one or both of the inverted velocity cone and the mesh screen (or other second-stage nucleation devices). However, it is noted that when the mesh screen is combined with such a distribution header and return line arrangement, that combined arrangement may be particularly good at recycling de-aerated fluid back into the lower chamber. For example, the mesh screen may bifurcate the upper chamber to define two volumes substantially only in fluid communication with one another through the mesh screen. In this arrangement, in order for hydraulic fluid entering the upper chamber via the central opening of the baffle to reach the distribution header, the hydraulic fluid may be required to pass through the mesh screen. In this particular combination or arrangement, any hydraulic fluid recycled through the distribution header, return line, and eductor to the return port has necessarily passed through the mess screen to incite nucleation or to promote de-aeration of the hydraulic fluid before the fluid is reintroduced to the cyclonic action of the lower chamber.

Thus, an improved cyclonic-type reservoir for de-aeration of a hydraulic fluid is disclosed in which various elements may be included for further promoting de-aeration. It is observed that the various structures for further promoting de-aeration of the fluid or for better separating aerated and non-aerated portions of the fluid are relatively passive in form. They are passive in that, once the structure is provided, no further direct energy may need to be exerted in order for these features to perform their function. For example, the mesh screen provides a nucleation surface, but does not require an excessive pumping force to draw the hydraulic fluid through it. Likewise, the Venturi effect assists in the reintroduction of the hydraulic fluid from the upper chamber to the lower chamber via the eductor and return port.

These and still other advantages of the invention will be apparent from the detailed description and drawings. What follows is merely a description of a preferred embodiment of the present invention. To assess the full scope of the invention the claims should be looked to as this preferred embodiment is not intended to be the only embodiment within the scope of the claims.

### BRIEF DESCRIPTION OF THE DRAWINGS

FIG. 1 is a front side perspective view of a reservoir according to one embodiment of the invention.

FIG. 2 is another perspective view of the reservoir of FIG. 1 in which a portion of the cylindrical side walls are broken away to reveal the upper and lower chambers separated by an intermediate baffle.

FIG. 3 is a cross-sectional side view taken through the central axis of the reservoir in order to illustrate the two chamber reservoir including the inverted velocity cone in the lower chamber and the mesh screen and the distribution header in the upper chamber.

FIG. 4 is a side plan view of the reservoir.

FIG. 5 is a top-down cross-sectional view taken through line 5-5 of FIG. 4, illustrating the components of the upper chamber of the reservoir.

FIG. 6 is a top-down cross-sectional view taken through line 6-6 of FIG. 4 extending through the central axis of the return port of the reservoir, illustrating the components of the lower chamber.

FIG. 7 is a top-down cross-sectional view taken through line 7-7 of FIG. 4 extending through the central axis of the suction port of the reservoir, further illustrating the components of the lower chamber.

FIG. 8 is a side cross-sectional view taken through line 8-8 of FIG. 5 in which the return port is sectioned to better illustrate the connection of the return line with the return port at an eductor.

FIG. 9 is a cross-sectional side view of the reservoir illustrating the flow patterns for the hydraulic fluid within the reservoir.

### DETAILED DESCRIPTION

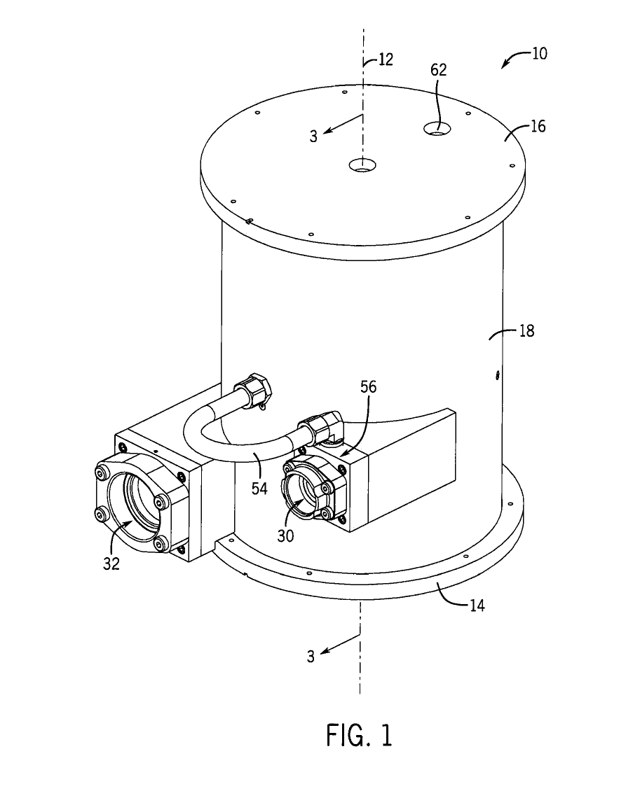

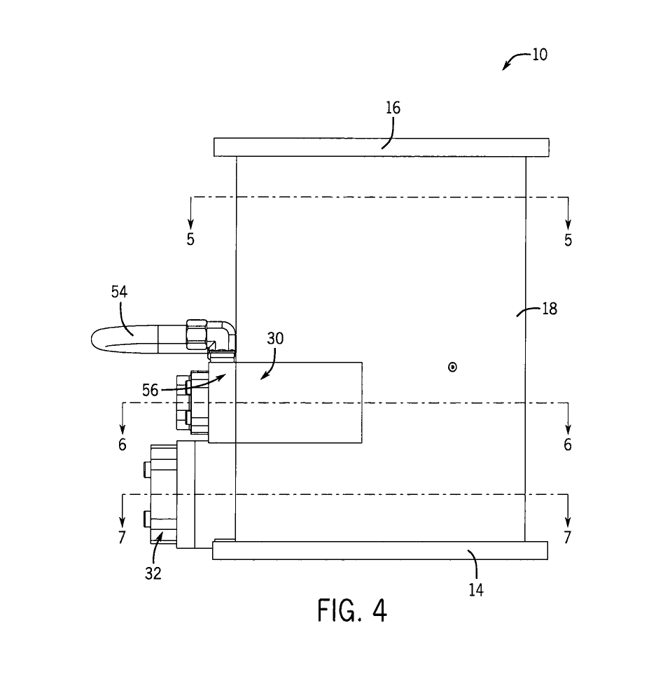

With reference being made to FIGS. 1 through 9, a reservoir 10 for hydraulic fluid according to one aspect of the invention is illustrated. As will be described in more detail below and with reference to the figures that follow, the reservoir 10 has two vertically-stacked internal chambers and is of a cyclonic type of reservoir in which a cyclonic flow pattern is created to assist in the separation of aerated hydraulic fluid from de-aerated or non-aerated hydraulic fluid before the hydraulic fluid is pumped back into the connected hydraulic system (not shown). Those skilled in the art will appreciate that this reservoir 10 is but one exemplary embodiment of a reservoir that falls within the scope of the invention and that variations may be made in construction without deviating from the scope of the claimed invention.

With specific reference to FIG. 1, from the exterior, it can be seen that the reservoir 10 is a generally cylindrically-shaped vessel extending along a vertically-aligned central axis 12. The outer structure of the reservoir 10 includes a bottom circular plate 14 and an opposing top circular plate 16 that joined by cylindrically-shaped side walls 18. The cylindrically-shaped side walls 18 are arranged such that their centerline is colinear with the central axis 12. These end plates 14 and 16 can be joined to the cylindrical side walls 18 in a number of ways to form a water-tight seal between the components. For example, the components might be welded together or fasteners might be used to connect the components to one another (potentially in conjunction with intermediate sealing gaskets). In the particular form illustrated, circular grooves are formed in the axial faces of the plates 14 into which the circumferential ends of cylindrically-shaped side walls 18 are seated or received.

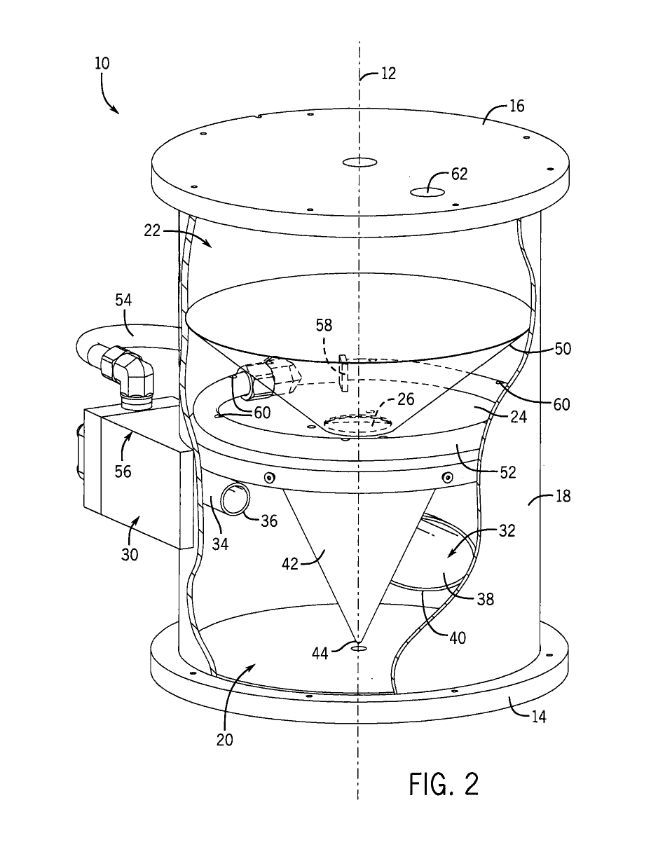

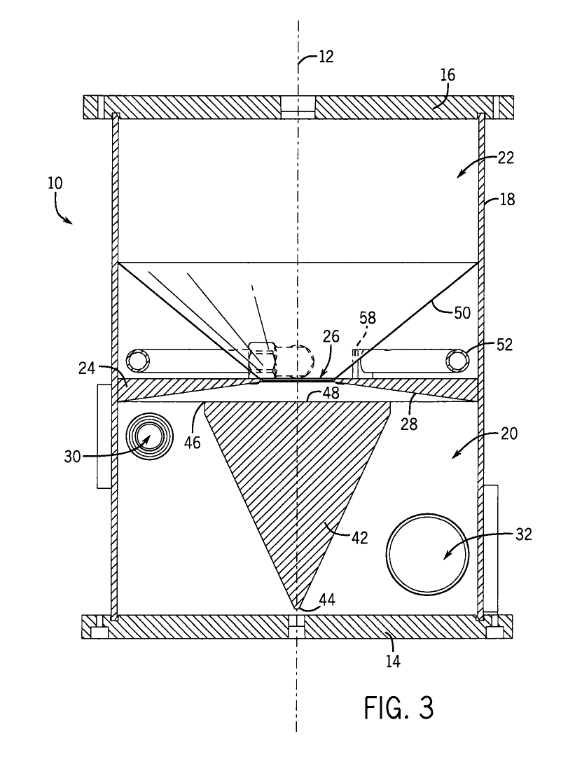

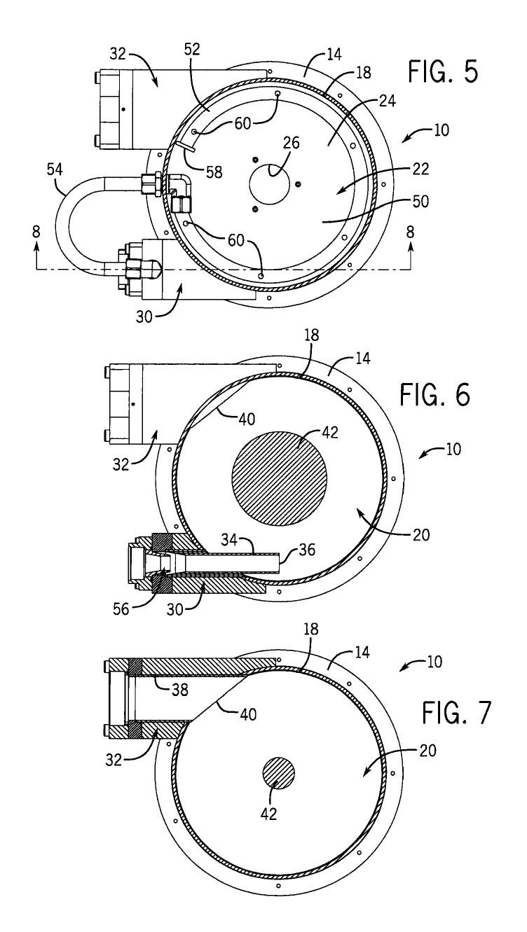

Now with additional reference to FIGS. 2 and 3 and the various cross sections of FIGS. 5 through 7, the inside of the reservoir 10 is shown along with its various components. In these views, it can be seen that the reservoir 10 is separated into a lower chamber 20 and an upper chamber 22 by an intermediate baffle 24. The intermediate baffle 24 is a generally disc-shaped wall that is substantially parallel with the end plates 14 and 16. The outer circumferential edge of the intermediate baffle 24 may be attached to the cylindrical-shaped side walls 18 with fasteners and/or welding, for example, although it is contemplated that this baffle 24 might be fixed or supported relative to the side walls 18 in other ways.

There is a central opening 26 in the intermediate baffle 24. This central opening 26 places the lower chamber 20 and the upper chamber 22 in fluid communication with one another. As will be described in greater detail below, when the reservoir 10 is filled with hydraulic fluid, the less dense or aerated portion of the fluid will tend to migrate upwards through this central opening 26 with cyclone assistance. With an understanding that more buoyant portions of the hydraulic fluid or entrapped gas bubbles will rise from the lower chamber 20 to the upper chamber 22 during operation of the reservoir 10 and circulation of the hydraulic fluid, a lower surface 28 of the baffle 24 may be angled upward (that is, extend axially upward) as the lower surface 28 radially approaches the central opening 26 as is best illustrated in the side cross-sectional view of FIG. 3. In the particular form shown, the lower surface 28 of the intermediate baffle 24 is generally frusto-conical in shape and is angled approximately 5 degrees downward from a plane perpendicular to the central axis 12.

Turning attention now to the lower chamber 20, it can be seen that there are two ports extending through the side walls 18 of the lower chamber 20 for transport of the hydraulic fluid to and from the inner volume of the reservoir 10. A return port 30 permits the introduction of hydraulic fluid to the lower chamber 20 of the reservoir 10 from the connected hydraulic system, while a suction port 32 accommodates the removal of hydraulic fluid from the lower chamber 20 of the reservoir 10 so that the fluid may be pumped back to the hydraulic system. The terms “return” and “suction” are used with respect to the attached system, since the return port 30 will carry fluid returning from the system, whilst the suction port 32 will carry fluid that is being sucked by a pump back into the system.

The return port 30 is oriented to introduce the hydraulic fluid into the lower chamber 20 in a direction generally tangential to the cylindrical side walls 18 so as to create or establish a cyclonic flow pattern in the lower chamber 20. In the illustrated structure, the cyclonic flow is induced in counter-clockwise direction when viewed from the top down. However, it is contemplated that the ports 30 and 32 might be differently positioned so that a cyclonic flow could be induced in the opposite direction. When the hydraulic fluid is subjected to this cyclonic flow pattern, the more dense, non-aerated or de-aerated portions of the hydraulic fluid will tend to move radially outward to the inside of the side walls 18 of the lower chamber 20 while the less dense, aerated portion of the hydraulic fluid will tend to move radially inward toward the central axis 12.

To help improve flow efficiency in the particular embodiment illustrated, the return port 30 includes a tube 34 having a cut end 36 extending into an inner volume of the lower chamber 20. This tube 34, though which the fluid enters the lower chamber 20, is straight and protrudes into the lower chamber 20, thereby allowing for an outside weld during fabrication of the reservoir 10. When fluid exits the return port 30 from the end 36 of the tube 34, the fluid enters the cyclonic flow in a tangential direction, thereby enhancing spin efficiency. Alternatively, the return port 30 could potentially eject the return flow at a location closer to the cylindrically side wall 18; for example, the outlet could be made substantially flush with the cylindrical side walls 18 and the inlet may have an outer wall that is substantially tangential with the side wall 18 at the location where the two meet. However, in such an arrangement, the particular flow exiting the return port 30 and entering the cyclone might be more turbulent and the manner in which the outlet is attached to the cylindrically-shaped side wall 18 may be made more mechanically complicated (as, for example, the connection might possibly require an weld inside the lower chamber 20 which would be moderately difficult to make during assembly).

The other port, the suction port 32, is oriented to receive the hydraulic fluid from the lower chamber 20 in a direction generally tangential to the cylindrical side walls 18. The suction port 18 includes a tube 38 with an end 40 having an angled cut that projects into the lower chamber 20.

The arrangement of the return port 30 relative to the suction port 32 may be made so as to promote separation of the aerated portion and non-aerated or de-aerated portion of the hydraulic fluid from one another and to avoid immediate re-introduction of the aerated portion of the fluid via the suction port 32. For example, in the particular embodiment illustrated, the return port 30 is disposed at a greater axial height than the suction port 32. This difference in axial height makes it more difficult for less dense, aerated portion of the hydraulic fluid entering via the return port 30 to enter the suction port 32 because, in order for this to happen, the aerated portion of the hydraulic fluid would actually need to vertically sink within the lower chamber 20 to reach the suction port 32. Further, the angular placement of the return port 30 and the suction port 32 on the side walls 18 may be altered to require any fluid entering the lower chamber 20 from the return port 30 to travel at least some angular distance in the cyclone before the fluid might possibly be received in the suction port 32. In the particular embodiment illustrated, the return port 30 and the suction port 32 are oriented such that that their respective linear flow paths therethrough are parallel and spaced from one another and opposite in flow direction. As such, the return port 30 and the suction port 32 are oriented with respect to one another such that the fluid would need to travel approximately between 180 and 270 degrees around the lower chamber 20 before the fluid could possibly be received by the suction port 32 (which also, in order to occur, would mean that the fluid would be have to drop the vertical axial distance over the partial rotation in the lower chamber 20 which is unlikely to occur at less than one full rotation given the rotational speeds and the vertical separation of the ports 30 and 32).

Now with particular reference to FIGS. 2, 3, 6, and 7, an inverted velocity cone 42 is illustrated as being centrally disposed in the lower chamber 20 such that the axis of the cone 42 is parallel and co-linear with the central axis 12 of the reservoir 10. This inverted velocity cone 42 extends for much, although not all of the vertical extent of the lower chamber 20. The inverted velocity cone 42 is oriented such that its tip 44 points downward toward the bottom plate 14 while its top rim 46 faces the lower surface 28 of the intermediate baffle 24. In the form illustrated, the circumference of the top rim 46 of the inverted velocity cone 42 is greater than the circumference of the central opening 26.

Although the particular manner of the fixing the inverted velocity cone 42 is not depicted in the figures, one having ordinary skill in the art will have an appreciation for the many ways that the cone 42 might be mounted within the lower chamber 20 without substantially disrupting cyclonic flow radially outward of the cone 42 between the radially outward facing walls of the cone 42 and the radially inward facing inner portion of the side walls 18. As one non-limiting example, standoffs might be fastened to extend out of the lower side of the intermediate baffle 24 and these standoffs could contact or mount to the top surface 48 of the inverted velocity cone 42 inward of the upper rim 46. Likewise, the tip 44 of the velocity cone 42 might in some way be seated or mounted to the bottom plate 14.

The presence of this inverted velocity cone 42 in the lower chamber 20 helps to create velocity differentials in the cyclonic flow of the hydraulic fluid at the upper end of the lower chamber 20 in comparison to the bottom end of the lower chamber 20. Particularly at the top end of the cone 42, where the cone 42 has its greatest circumference, the cross sectional area in which hydraulic fluid can cyclonically flow (i.e., the space between the outer diameter of the cone 42 and the inner diameter of the cylindrically shaped side walls 18) is less than at a location vertically downward and that is closer to the bottom end of the cone 42, at which the cross sectional area between the cone 42 and the side walls 18 is greater. Compare, for example, the different cross sectional areas of FIGS. 6 and 7. This difference in cross sectional areas for fluid to flow (as well as, notably, the distance of these flow paths from the central axis 12) means that the fluid traveling near the top end of the cone 42 is accelerated relative to fluid at the bottom end of the cone 42. This difference in velocities, incited by the presence of the cone 42 in the lower chamber 20, results in improved separation of the dense, non-aerated or de-aerated fluids from the less dense, aerated fluids, particularly in the upper regions of the cone 42 at which the fluid is introduced via the return port 30. This separation results from the application of the centrifugal force that causes the heavier portion of the fluid to move to the radially outward while the lighter portion of the fluid moves inward. Further, this increased velocity adds more momentum to the fluid at the top end of the lower chamber, driving entrapped gas bubbles together with greater force in the upper region of the cone 42 to aggregate them. Moreover, at the bottom end of the cone 42, the smaller diameter of the cone 42 will position any aerated fluid (which will tend to move toward the center of the chamber near the cone 42) in this region further from the suction port 32, thereby limiting the re-entry of aerated fluid into the attached system.

As used herein, the term “inverted velocity cone” is intended to include any form having a cross section with an outer periphery that is generally circular in form and in which the circumference of the circular outer periphery generally decreases or remains the same as the section is taken at lower vertical heights once placed in the reservoir. Accordingly, the inverted velocity cone 42 can include not only cones having a straight tapper extending from the upper rim 42 towards a lower tip 44, but also other profiles (for example, hyperbolic forms). The use of the word “generally” in describing the circular form and the decreasing outer periphery is intended to indicate that such decrease in periphery is not strict and may include minor or localized points of increase. For example, it is contemplated that in some forms of the cone 42, helical channels or protrusions may exist around the cone 42 to influence flow patterns of the hydraulic fluid. Such features are contemplated as being includable on an inverted velocity cone. It will further be appreciated that the cone 42 might not extend fully to a pointed tip as illustrated, but may instead be truncated prior to a sharp tip. In some forms, truncation may even be preferable, as a flat truncated lower end may be more easily mounted to a bottom wall of the lower chamber 20. Still yet, it is contemplated that the inverted velocity cone might be a solid body (as illustrated) or have portions that are hollow. In one form, the hollow form may extend up to the upper rim and terminate and the upper surface may not extend from one side of the upper rim directly across to the other side.

In any event, the presence of the inverted velocity cone 42 in the lower chamber 20 promotes separation of the aerated portions of the hydraulic fluid from the de-aerated or non-aerated portions of the hydraulic fluid during cyclonic flow in the lower chamber 20. The de-aerated or non-aerated portions of the hydraulic fluid will tend to drop within the lower chamber 20 upon separation and be positioned for reception in the suction port 30 for re-entry into the attached hydraulic system. Meanwhile, the aerated portions of the hydraulic fluid will tend to rise upward in the lower chamber 20 and ultimately migrate or flow between the upper rim 46/top surface 48 of the inverted velocity cone 42 and the canted lower surface 28 of the baffle 24. This aerated portion of the hydraulic fluid will flow up into the upper chamber 22 through the central opening 26 of the intermediate baffle 24.

Turning attention to the upper chamber 22 and FIGS. 2, 3, 5, and 8, it can be seen that there is additional structure present in the upper chamber 22 to assist in the de-aeration of the separated fluid and to help recycle or return the de-aerated portion of the hydraulic fluid from the upper chamber 22 back into the lower chamber 20 for further processing and potential reintroduction into the attached hydraulic system. Most notably, the upper chamber 22 includes a mesh screen 50 and a distribution header 52 that is fluidly connected, via an external return line 54 (see FIGS. 1, 4, and 8), to the return port 30 at an eductor 56.

In the form illustrated, the mesh screen 50 is extends around a lower end of the upper chamber 22 and is generally frusto-conical in shape, being attached at a lower end to the intermediate baffle 24 proximate the central opening 26 and also being attached to the radially inward facing side of the side walls 18. These points of attachment for the mesh screen 50 may occur in a number of ways such as for example, but not limited to, welding, fastening, adhering (using chemically compatible adhesives), and so forth.

In the volume between the mesh screen 50, the side walls 18 and the intermediate baffle 24, the distribution header 52 is positioned. As illustrated, the distribution header 52 is a tube that runs along a partial circumferential path. The header 52 is capped on one end 58 and extends radially through the side wall 18 to connect to the return line 54. On its upper surface, the header 52 includes a plurality of openings 60 that place the inner volume of the upper chamber 22 in fluid communication with the inner volume of the distribution header 52 (and therefore the return line 54 and return port 30 via their connection to one another).

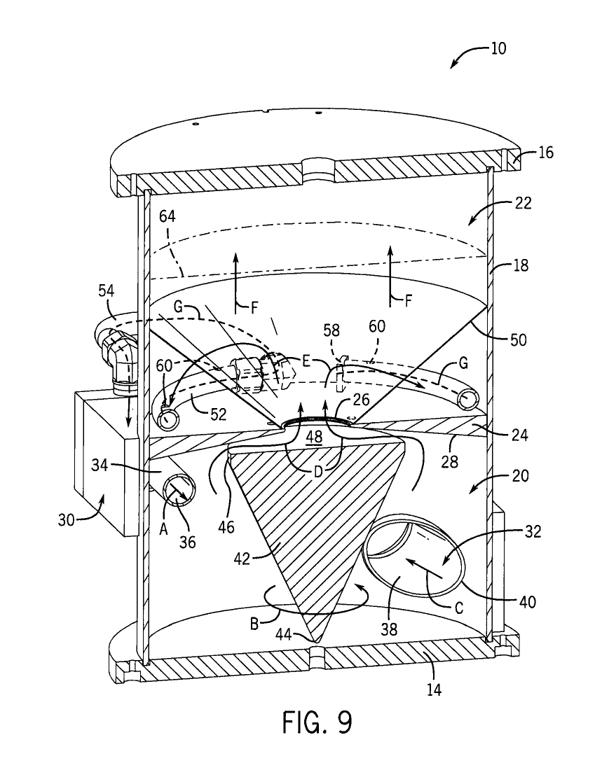

At least a portion of the hydraulic fluid entering the upper chamber 22 will flow to and through the mesh screen 50 and into the plurality of openings 60 in the distribution header 52. Notably, the mesh screen 50 provides a material through which the hydraulic fluid is able to flow, but additionally provides a surface on which entrapped gas in the hydraulic fluid can nucleate and collect. The gas that nucleates and collects on the mesh screen 50 eventually reaches a critical size, at which point the collected gas bubble separates from the mesh screen 50 and floats upward toward an upper fill line 64 (see FIG. 9) of the hydraulic fluid in the upper chamber 22. At the upper fill line, the gas can escape from the fluid and exit the reservoir 10 via an upper opening 62 in the top plate 16.

In the particular embodiment illustrated, a 60 mesh screen size is used to provide this nucleation surface and the mesh screen 50 is oriented at an angle of approximately 30 degrees from a plane perpendicular to the central axis 12. However, it is contemplated that other shapes and sizes of screens might be used.

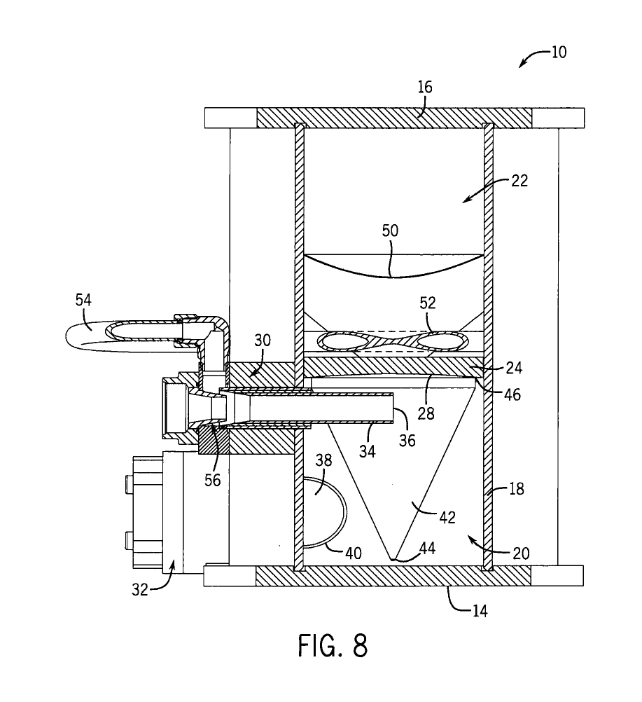

The presence of the distribution header 52 may also help to establish a driving force for the fluid to flow through the mesh screen 50. With additional reference to FIG. 8, it can be seen that the distribution header 52 connects to the return line 54 which connects to the return port 30 at the eductor 56. This eductor 56 creates a venturi by virtue of the flow through the return port 30 that will draw fluid from the return line 54 into the flow of the return port 30. This effectively creates a driving force which pulls fluid from the upper chamber 22 (after the fluid has passed through the mesh screen 50 as a second stage de-aeration device) back into the entry flow into the lower chamber 20. Thus, the fluid re-entering the return port 30 via the return line 54 and eductor 56 is less aerated that the fluid that initially entered the upper chamber 22 after initial separation by the cyclonic flow in the lower chamber 20.

In view of the above-described structure and to summarize the manner in which the hydraulic fluid is circulated and de-aerated by the reservoir 10, reference is now made to FIG. 9. In FIG. 9, dark arrows provided with alphabetical references are used to indicate flow. As indicated by arrow A, hydraulic fluid returning from the attached system initially enters the lower chamber 20 of the reservoir 10 via the return port 30. This fluid is then cyclonically spun through the lower chamber 20 about the inverted velocity cone 42 as indicated by arrow B to separate the heavier fluid (which is non-aerated or has been de-aerated) from the less dense fluid (which is aerated). The dense separated portion of the fluid is permitted to be pumped out of the lower chamber 20 via the suction port 32 along the arrow C. The less dense fluid, which is likely or potentially aerated, flows centrally per arrow B toward the inverted velocity cone 42 and flows or migrates up between the top of the cone 42 and the lower surface 28 of the baffle 24 and through the central opening 26 according to arrows D. This separated fluid enters the upper chamber 22 and flows along arrows E through the mesh screen 50 by the draw of the distribution header 52. Along this path, the gasses entrapped in the fluid may collect or nucleate on the mesh screen 50 and, once a sufficient gas mass has collected on the screen 50, the gas will bubble up along arrows F to the upper fill line of the fluid in the upper chamber 22 to exit the hydraulic fluid. The fluid that has passed through the mesh screen 50 to enter the distribution header 52 will flow through the openings 60 in distribution header 52 and into the return line 54 along arrow G. At the end of the return line 54, the de-aerated fluid is combined with the entering fluid from the system at the return port at the eductor 56, completing a de-aeration circuit of flow. This combined fluid then returns to the cyclonic processing of the lower chamber 20 to further process and de-aerate the fluid.

It will be appreciated that, while one embodiment is described above in which the upper chamber, the lower chamber, and their connecting central opening are positioned along a central axis, that this specific arrangement of the chambers and the opening is not required and the chambers may not share a central axis. For example, a tube or pipe may provide the central opening at the top of the lower chamber and connect the lower chamber to an upper chamber located some greater distance away from the lower chamber. Particularly in the instances in which space does not accommodate the close positioning of the upper and lower chambers to one another, a separated, but connected arrangement may be of benefit. In this configuration in particular, and in other arrangements as well, walls of the chambers could be separately formed and the upper and lower chambers may not have shared structural elements (i.e., the cylindrical side wall and the intermediate baffle).

As noted above, it should be appreciated that the inverted velocity cone, the mesh screen, and the recycling of the fluid via the distribution header and eductor may be practiced separately or in various combinations with one another. It should be appreciated that various other modifications and variations to the preferred embodiments can be made within the spirit and scope of the invention. Therefore, the invention should not be limited to the described embodiments. To ascertain the full scope of the invention, the following claims should be referenced.

1. A hydraulic fluid reservoir for de-aerating a hydraulic fluid received therein, the hydraulic fluid reservoir having a lower chamber and an upper chamber, the lower chamber and the upper chamber being separated by an intermediate baffle with a central opening relative to the lower chamber formed therein that places the upper chamber and the lower chamber in fluid communication with one another, the lower chamber having a return port for introducing the hydraulic fluid to the lower chamber to create a cyclonic flow in the lower chamber and the lower chamber further having a suction port for removing the hydraulic fluid from the lower chamber, the hydraulic fluid reservoir comprising a lower surface of the intermediate baffle that extends upward in the axial direction as the lower surface of the baffle extends radially toward the central opening wherein the lower surface of the intermediate baffle provides a gravity-assisted path for gas bubbles in the hydraulic fluid to rise from the lower chamber into the upper chamber and to be directed through the central opening of the intermediate baffle.

2. The hydraulic fluid reservoir of claim 1, wherein the return port and the suction port extend through generally cylindrical side walls of the lower chamber, wherein the return port is oriented to introduce the hydraulic fluid into the lower chamber in a direction generally tangential to the cylindrical side walls and the suction port is oriented to receive the hydraulic fluid from the lower chamber in a direction generally tangential to the cylindrical side walls, and wherein the return port is disposed at a greater axial height than the suction port.

3. The hydraulic fluid reservoir of claim 4, wherein a radial distance from the return port to the inverted velocity cone at an axial height of the return port is less than a radial distance from the suction port to the inverted velocity cone at an axial height of the suction port.

4. The hydraulic fluid reservoir of claim 1, further comprising an inverted velocity cone axially disposed in the lower chamber of the hydraulic fluid reservoir that generates a velocity differential between the hydraulic fluid spinning at a top end of the lower tank in comparison to the hydraulic fluid spinning at a lower end of the lower chamber, thereby improving separation of aerated and de-aerated portions of the hydraulic fluid from one another in the lower chamber and wherein the lower surface of the intermediate baffle provides a flow path from the lower chamber to the upper chamber between a top rim of the inverted velocity cone.

5. The hydraulic fluid reservoir of claim 1, in which the return port comprises a tube having an end extending into an inner volume of the lower chamber such that, when fluid exits the return port from the end of the tube, the fluid enters the cyclonic flow in a tangential direction thereby enhancing spin efficiency.

6. The hydraulic fluid reservoir of claim 5, wherein the tube is straight and protrudes into the lower chamber thereby allowing for an outside weld during fabrication.

7. The hydraulic fluid reservoir of claim 1, wherein the suction port includes a tube with an end having an angled cut that projects into the lower chamber to improve manufacturability without reducing spin performance.

8. The hydraulic fluid reservoir of claim 1, wherein the upper chamber includes a mesh screen for initiating nucleation of an aerated portion of the hydraulic fluid.

9. The hydraulic fluid reservoir of claim 8, wherein the mesh screen is frusto-conical in shape and extends axially upward as the mesh screen extends radially away from the central opening of the baffle.

10. The hydraulic fluid reservoir of claim 8, further comprising a distribution header in the upper chamber in which the distribution header is in fluid communication with the return port via a return line connecting to the return port at an eductor, thereby permitting direct reintroduction of fluid from the upper chamber into the lower chamber via the return port.

11. A hydraulic fluid reservoir for de-aerating a hydraulic fluid received therein, the hydraulic fluid reservoir having a lower chamber and an upper chamber, the lower chamber and the upper chamber being separated by an intermediate baffle with a central opening relative to the lower chamber formed therein that places the upper chamber and the lower chamber in fluid communication with one another, the lower chamber having a return port for introducing the hydraulic fluid to the lower chamber to create a cyclonic flow in the lower chamber and the lower chamber further having a suction port for removing the hydraulic fluid from the lower chamber, the hydraulic fluid reservoir comprising a mesh screen received in the upper chamber for initiating nucleation of a gas from an aerated portion of the hydraulic fluid.

12. The hydraulic fluid reservoir of claim 11, wherein the mesh screen is frusto-conical in shape and extends axially upward as the mesh screen extends radially away from the central opening of the baffle.

13. The hydraulic fluid reservoir of claim 11, further comprising a distribution header in the upper chamber in which the distribution header is in fluid communication with the return port via a return line connecting to the return port at an eductor, thereby permitting direct reintroduction of fluid from the upper chamber into the lower chamber via the return port.

14. The hydraulic fluid reservoir of claim 13, wherein the mesh screen bifurcates the upper chamber to define two volumes substantially only in fluid communication with one another through the mesh screen such that, in order for hydraulic fluid entering the upper chamber via the central opening of the baffle to reach the distribution header, the hydraulic fluid must pass through the mesh screen.

15. The hydraulic fluid reservoir of claim 11, wherein the mesh screen is a 60 mesh screen and is angled 30 degrees from a plane perpendicular from the central axis vertically extending through the hydraulic fluid reservoir.

16. The hydraulic fluid reservoir of claim 11, further comprising an inverted velocity cone axially disposed in the lower chamber of the hydraulic fluid reservoir that generates a velocity differential between the hydraulic fluid spinning at a top end of the lower tank in comparison to the hydraulic fluid spinning at a lower end of the lower chamber, thereby improving separation of aerated and de-aerated portions of the hydraulic fluid from one another in the lower chamber.

17. A hydraulic fluid reservoir for de-aerating a hydraulic fluid received therein, the hydraulic fluid reservoir having a lower chamber and an upper chamber, the lower chamber and the upper chamber being separated by an intermediate baffle with a central opening relative to the lower chamber formed therein that places the upper chamber and the lower chamber in fluid communication with one another, the lower chamber having a return port for introducing the hydraulic fluid to the lower chamber to create a cyclonic flow in the lower chamber and the lower chamber further having a suction port for removing the hydraulic fluid from the lower chamber, the hydraulic fluid reservoir comprising a distribution header in the upper chamber in which the distribution header is in fluid communication with the return port via a return line connecting to the return port at an eductor, thereby permitting direct reintroduction of fluid from the upper chamber into the lower chamber via the return port.

18. The hydraulic fluid reservoir of claim 17, wherein the eductor provides a venturi at the joint of the eductor and the return port to draw fluid from the upper chamber through the return line and the eductor into the return port for reintroduction into the lower chamber.

19. The hydraulic fluid reservoir of claim 17, further comprising a mesh screen received in the upper chamber for initiating nucleation of a gas from an aerated portion of the hydraulic fluid.

20. The hydraulic fluid reservoir of claim 17, further comprising an inverted velocity cone axially disposed in the lower chamber of the hydraulic fluid reservoir that generates a velocity differential between the hydraulic fluid spinning at a top end of the lower tank in comparison to the hydraulic fluid spinning at a lower end of the lower chamber, thereby improving separation of aerated and de-aerated portions of the hydraulic fluid from one another in the lower chamber.
